(19) United States
(12) Patent Application Publication
(10) Pub. No.: US 2026/0270589 A1
(43) Pub. Date: Sep. 10, 2026

(54) VISION SENSOR CHIP

(71) Applicant: TSINGHUA UNIVERSITY, Beijing (CN)

(72) Inventors: Rong ZHAO, Beijing (CN); Yuguo CHEN, Beijing (CN); Taoyi WANG, Beijing (CN); Yihan LIN, Beijing (CN); Luping SHI, Beijing (CN)

(21) Appl. No.: 19/664,183

(22) Filed: Apr. 30, 2026

Related U.S. Application Data
(63) Continuation-in-part of application No. PCT/CN2024/116942, filed on Sep. 4, 2024.
(63) Continuation-in-part of application No. PCT/CN2024/116929, filed on Sep. 4, 2024.

(30) Foreign Application Priority Data
Oct. 30, 2023 (CN) 202311423882.8
Mar. 28, 2024 (CN) 202410367153.3

(51) Int. Cl. H04N 25/77; H04N 25/78

(52) U.S. Cl. CPC H04N 25/77; H04N 25/78

(57) ABSTRACT

The present application provides a visual sensor chip and an imaging system. The vision sensor chip includes a pixel array, at least one temporal difference pathway or a spatial difference pathway. The temporal difference pathway is configured to perform weighted difference and quantization operations in a domain on a signal at a position of a current pixel at a current time and a signal at the position of the current pixel at any previous time to obtain one or more types of multi-scale temporal difference value. The spatial difference pathway is configured to perform weighted difference and quantization operations in the domain on the signal at the position of the current pixel at the current time and a signal at a position of any spatial pixel at the current time to obtain one or more types of multi-scale spatial difference value.

### CROSS-REFERENCES TO RELATED APPLICATIONS

The present application is a Continuation in Part of International Patent Application No. PCT/CN2024/116942, filed on Sep. 4, 2024, which claims priority to and the benefit of Chinese Patent Application No. 202410367153.3, filed on Mar. 28, 2024, and is a Continuation in Part of International Patent Application No. PCT/CN2024/116929, filed on Sep. 4, 2024, which claims priority to and the benefit of Chinese Patent Application No. 202311423882.8, filed on Oct. 30, 2023, which are hereby incorporated by reference in their entireties herein.

### FIELD

The present application relates to the field of vision sensing, and in more particular, to a vision sensor chip based on multi-scale spatiotemporal difference technology.

### BACKGROUND

A vision sensor is a photoelectric detection device capable of perceiving visible light information within an environment and converting the visible light information into electrical signals. Various types of vision sensors such as a complementary metal-oxide-semiconductor (CMOS) image sensor (CIS), a dynamic vision sensor (DVS) have been developed to provide high-performance image information of an object. However, traditional vision sensors are unable to determine spatiotemporal correlations with signals from earlier times or with signals beyond immediately adjacent pixels and have the problem of having a limited spatiotemporal receptive field.

### BRIEF SUMMARY

According to the present application, there is provided a vision sensor chip based on a multi-scale spatiotemporal difference technology to solve defects of limited spatiotemporal receptive field in the related art since the traditional vision sensors are unable to determine spatiotemporal correlations with earlier signals or with signals beyond adjacent pixels. By extending temporal difference and spatial difference to a multi-scale mode, the present application facilitates the analysis of spatiotemporal signal correlations, achieves a larger spatiotemporal receptive field, and generates efficient and robust visual representations.

According to the present application, there is provided a vision sensor chip based on a multi-scale spatiotemporal difference technology, including a pixel array including a plurality of pixels, a temporal difference pathway and a spatial difference pathway; where the temporal difference pathway is configured to perform weighted difference and quantization operations in a charge domain, an analog domain, or a digital domain on a signal at a position of a current pixel at a current time and a signal at the position of the current pixel at any previous time to obtain one or more types of multi-scale temporal difference value; and the spatial difference pathway is configured to perform weighted difference and quantization operations in the charge domain, the analog domain, or the digital domain on the signal at the position of the current pixel at the current time and a signal at a position of any spatial pixel at the current time to obtain one or more types of multi-scale spatial difference value.

According to the vision sensor chip based on the multi-scale spatiotemporal difference technology of the present application, the temporal difference pathway includes a plurality of temporally differential storage nodes, a temporal differentiator, and a temporal quantizer; the plurality of temporally differential storage nodes are configured to store electrical signals at the position of the current pixel at a plurality of different times, respectively; and the temporal differentiator is configured to perform weighted temporal difference operation on an electrical signal at the position of the current pixel at the current time and an electrical signal at the position of the current pixel at any previous time based on the electrical signals at the position of the current pixel at the plurality of different times to obtain the multi-scale temporal difference values, where analog-to-digital signal conversion is performed by the temporal quantizer during a multi-scale temporal difference process; the spatial difference pathway includes a spatially differential storage node multiplexed with one of the plurality of temporally differential storage nodes, a spatial differentiator, and a spatial quantizer; the spatially differential storage node is configured to store the electrical signal at the position of the current pixel at the current time; and the spatial differentiator is configured to perform weighted spatial difference operation on the electrical signal at the position of the current pixel at the current time and an electrical signal at the position of any spatial pixel at the current time to obtain multi-scale spatial difference values, where the analog-to-digital signal conversion is performed by the spatial quantizer during a multi-scale spatial difference process.

According to the vision sensor chip based on the multi-scale spatiotemporal difference technology of the present application, at least one of the temporal differentiator or the temporal quantizer is provided inside the pixel, and uses a pixel-level signal readout mode; or at least one of the temporal differentiator or the temporal quantizer is provided outside the pixel and shared by pixels located in a same column and uses a column-level signal readout mode; and at least one of the spatial differentiator or the spatial quantizer is provided inside the pixel and uses the pixel-level signal readout mode; or at least one of the spatial differentiator or the spatial quantizer is provided outside the pixel and shared by pixels located in the same column and uses the column-level signal readout mode.

According to the vision sensor chip based on the multi-scale spatiotemporal difference technology of the present application, each pixel of the pixel array is provided with a single pulse generator; or all pixels in the pixel array are collectively connected to a single pulse generator; or the pixel array is partitioned into a plurality of sub-regions and all pixels in each sub-region are collectively connected to a single pulse generator; where the pulse generator is configured to generate a trigger signal at a fixed time interval, or at adaptive, programmable, and variable intervals to control a start exposure time and an exposure duration of a photoreceptor; pixels connected to a same pulse generator perform synchronous exposure, and pixels connected to different pulse generators perform either synchronous or asynchronous exposure; and where the photoreceptor is provided inside the pixel and is configured to convert a photosignal received at the position of the current pixel into an analog electrical signal.

According to the vision sensor chip based on the multi-scale spatiotemporal difference technology of the present application, an exposure mode for each pixel of the pixel array is a global shutter or a rolling shutter.

According to the present application, there is further provided a multi-pathway vision sensor chip based on a multi-scale spatiotemporal difference technology, including a pixel array, an intensity pathway and at least one of a temporal difference pathway or a spatial difference pathway and the pixel array includes a plurality of pixels; where the intensity pathway is configured to determine a quantized value of an electrical signal converted from intensity of incident light at a position of a current pixel at a current time; the temporal difference pathway is configured to perform weighted difference and quantization operations in a charge domain, an analog domain, or a digital domain on a signal at the position of the current pixel at the current time and a signal at the position of the current pixel at any previous time to obtain one or more types of multi-scale temporal difference value; and the spatial difference pathway is configured to perform weighted difference and quantization operations in the charge domain, the analog domain, or the digital domain on the signal at the position of the current pixel at the current time and a signal at a position of any spatial pixel at the current time to obtain one or more types of multi-scale spatial difference value.

According to the multi-pathway vision sensor chip based on the multi-scale spatiotemporal difference technology of the present application, the pixel array includes a single type of pixel provided with an intensity pathway, and at least one of a temporal difference pathway or a spatial difference pathway corresponding to the single type of pixel; or the pixel array includes two types of pixels, where a first type of pixel is provided with an intensity pathway, and a second type of pixel is provided with at least one of a temporal difference pathway or spatial difference pathway.

According to the multi-pathway vision sensor chip based on the multi-scale spatiotemporal difference technology of the present application, the intensity pathway includes an intensity storage node and an intensity quantizer, the intensity storage node is configured to store the electrical signal converted from the intensity of the incident light at the position of the current pixel at the current time; the intensity quantizer is configured to perform analog-to-digital conversion on the electrical signal converted from the intensity of the incident light at the position of the current pixel at the current time to obtain a quantized value of the electrical signal converted from the intensity of the incident light at the position of the current pixel at the current time; the temporal difference pathway includes a plurality of temporally differential storage nodes, a temporal differentiator, and a temporal quantizer; the plurality of temporally differential storage nodes are configured to store electrical signals at the position of the current pixel at a plurality of different times, respectively; the temporal differentiator is configured to perform weighted temporal difference operation on the electrical signal at the position of the current pixel at the current time and the electrical signal at the position of the current pixel at any previous time based on the electrical signals at the position of the current pixel at the plurality of different times to obtain the multi-scale temporal difference values, where analog-to-digital signal conversion is performed by the temporal quantizer during a multi-scale temporal difference process; the spatial difference pathway includes a spatially differential storage node multiplexed with one of the temporally differential storage nodes, a spatial differentiator, and a spatial quantizer; the spatially differential storage node is configured to store the electrical signal at the position of the current pixel at the current time; and the spatial differentiator is configured to perform weighted spatial difference operation on the electrical signal at the position of the current pixel at the current time and an electrical signal at the position of any spatial pixel at the current time to obtain multi-scale spatial difference values, where the analog-to-digital signal conversion is performed by the spatial quantizer during a multi-scale spatial difference process.

According to the multi-pathway vision sensor chip based on the multi-scale spatiotemporal difference technology of the present application, the intensity quantizer is provided inside the pixel, and uses a pixel-level signal readout mode; or the intensity quantizer is provided outside the pixel and shared by pixels located in a same column and uses a column-level signal readout mode; and at least one of the temporal differentiator or the temporal quantizer is provided inside the pixel and uses the pixel-level signal readout mode; or at least one of the temporal differentiator or the temporal quantizer is provided outside the pixel and shared by pixels located in the same column and uses the column-level signal readout mode; at least one of the spatial differentiator or the spatial quantizer is provided inside the pixel, and uses the pixel-level signal readout mode; or at least one of the spatial differentiator or the spatial quantizer is provided outside the pixel and shared by pixels located in the same column and uses the column-level signal readout mode.

According to the multi-pathway vision sensor chip based on the multi-scale spatiotemporal difference technology of the present application, each pixel of the pixel array is provided with a single pulse generator; or all pixels in the pixel array are collectively connected to a single pulse generator; or the pixel array is partitioned into a plurality of sub-regions and all pixels in each sub-region are collectively connected to a single pulse generator; where the pulse generator is configured to generate a trigger signal at a fixed time interval, or at adaptive, programmable, and variable intervals to control a start exposure time and an exposure duration of a photoreceptor; pixels connected to a same pulse generator perform synchronous exposure, and pixels connected to different pulse generators perform either synchronous or asynchronous exposure; and where the photoreceptor is provided inside the pixel and is configured to convert a photosignal received at the position of the current pixel into an analog electrical signal.

According to the multi-pathway vision sensor chip based on the multi-scale spatiotemporal difference technology of the present application, an exposure mode for each pixel of the pixel array is a global shutter or a rolling shutter.

According to the present application, there is provided a vision sensor chip based on a multi-scale spatiotemporal difference technology, including a pixel array including a plurality of pixels, at least one of a temporal difference pathway or a spatial difference pathway; where the temporal difference pathway is configured to perform weighted difference and quantization operations in a charge domain, an analog domain, or a digital domain on a signal at a position of a current pixel at a current time and a signal at the position of the current pixel at any previous time to obtain one or more types of multi-scale temporal difference value; and the spatial difference pathway is configured to perform weighted difference and quantization operations in the charge domain, the analog domain, or the digital domain on the signal at the position of the current pixel at the current time and a signal at a position of any spatial pixel at the current time to obtain one or more types of multi-scale spatial difference value. By extending the temporal difference and the spatial difference to a multi-scale mode, the present application facilitates the analysis of the spatiotemporal correlation of signals and provides a larger spatiotemporal receptive field.

According to the present application, there is provided a vision sensor chip based on an adaptive sampling technology, including a plurality of pixels, an internal update buffer, and a spatiotemporal difference calculator; where each of the plurality of pixels is provided with a photoreceptor and a calculation signal buffer including a temporary buffer node and a historical buffer node, where the photoreceptor is configured to determine an electrical signal at the position of the current pixel, the electrical signal includes a temporary signal and a historical signal; the calculation signal buffer is configured to output a calculation signal in case that a calculation condition is satisfied, and to not output the calculation signal in case that the calculation condition is not satisfied, the calculation condition is that a difference value between the temporary signal and the historical signal is greater than a preset threshold, the calculation signal is a signal for difference calculation in a sampling selection mode being either an adaptive sampling mode or a non-adaptive sampling mode, the temporary signal is stored in the temporary buffer node and the historical signal is stored in the historical buffer node; the internal update buffer is configured to update the historical signal with the temporary signal in the adaptive sampling mode and in case that the calculation condition is satisfied and not to update the historical signal in the adaptive sampling mode and in case that the calculation condition is not satisfied and update the historical signal with the temporary signal during every sampling in the non-adaptive sampling mode; and the spatiotemporal difference calculator is configured to determine a spatiotemporal difference value based on the calculation signal.

According to the vision sensor chip based on the adaptive sampling technology of the present application, the preset threshold is a fixed, programmable, or adaptive value.

According to the vision sensor chip based on the adaptive sampling technology of the present application, the photoreceptor includes a photodiode, a transfer switch transistor, a reset switch transistor, and a buffer, where an anode of the photodiode is grounded, a cathode of the photodiode is connected to a first terminal of the transfer switch transistor; a second terminal of the transfer switch transistor is connected to a first terminal of the reset switch transistor and to a first terminal of the buffer, respectively; a second terminal of the reset switch transistor is connected to a positive power supply terminal; and a second terminal of the buffer serves as an output terminal of the photoreceptor.

According to the vision sensor chip based on the adaptive sampling technology of the present application, the temporary buffer node includes a temporary buffer switch transistor and a temporary buffer capacitor; the historical buffer node includes a historical buffer switch transistor and a historical buffer capacitor; and the internal update buffer is a differential comparator; a first terminal of the temporary buffer switch transistor is connected to a second terminal of the buffer and to a first terminal of the historical buffer switch transistor, respectively; a second terminal of the temporary buffer switch transistor is connected to a first terminal of the temporary buffer capacitor and to a first input terminal of the differential comparator, respectively; a second terminal of the temporary buffer capacitor is grounded; a second terminal of the historical buffer switch transistor is connected to a first terminal of the historical buffer capacitor and to a second input terminal of the differential comparator, respectively; a second terminal of the historical buffer capacitor is grounded; and an output terminal of the differential comparator serves as an output terminal of the internal update buffer.

According to the vision sensor chip based on the adaptive sampling technology of the present application, the photoreceptor is configured to acquire photosignals at the position of the current pixel at either a same time interval or an adaptive and programmable time interval.

According to the vision sensor chip based on the adaptive sampling technology of the present application, each pixel is provided with a single internal update buffer.

According to the vision sensor chip based on the adaptive sampling technology of the present application, the plurality of pixels share a single internal update buffer.

According to the vision sensor chip based on the adaptive sampling technology of the present application, the spatiotemporal difference calculator is configured to perform spatiotemporal difference calculation based on the calculation signal of a single pixel, and/or to perform the spatiotemporal difference calculation based on calculation signals of a pixel macroblock, where the pixel macroblock includes a plurality of pixels located within a preset region.

According to the vision sensor chip based on the adaptive sampling technology of the present application, the vision sensor chip further includes a convolver configured to perform convolution processing on the calculation signal or the spatiotemporal difference value to obtain a convolved spatiotemporal difference value.

According to the present application, there is further provided an imaging system including the aforementioned the vision sensor chip based on the adaptive sampling technology.

According to the present application, there is further provided a vision sensor chip based on an adaptive sampling technology and an imaging system, where the vision sensor includes a plurality of pixels, an internal update buffer, and a spatiotemporal difference calculator; and each of the plurality of pixels is provided with a photoreceptor and a calculation signal buffer. The photoreceptor determines an electrical signal at a position of a current pixel; the calculation signal buffer outputs a calculation signal in case that a calculation condition is satisfied, and otherwise, does not output a calculation signal; the internal update buffer updates a historical signal with a temporary signal in case of an adaptive sampling mode and in case that the calculation condition is satisfied; does not update the historical signal in the adaptive sampling mode and in case that the calculation condition is not satisfied; and updates the historical signal with the temporary signal during every sampling in the non-adaptive sampling mode; and the spatiotemporal difference calculator determines a spatiotemporal difference value based on the calculation signal, achieving adaptive sampling-based visual perception characterized by lower bandwidth, lower noise, and higher precision.

### BRIEF DESCRIPTION OF THE DRAWINGS

To illustrate solutions of the present application or in the related art more clearly, accompanying drawings that needs to be used in the description of the embodiments or the related art are briefly described below. The drawings described below are only some embodiments of the present application. For those skilled in the art, other drawings may also be obtained based on these drawings without creative effort.

FIG. 1 is a schematic diagram of a multi-scale tri-multiplexed pixel according to the present application;

FIG. 2 is a schematic diagram of a unidirectionally extended multi-scale spatial difference according to the present application;

FIG. 3 is a schematic diagram of a freely extended multi-scale spatial difference according to the present application;

FIG. 4 is a schematic diagram of a spatiotemporal difference pixel satisfying multi-scale TD and SD output requirements according to the present application;

FIG. 5 is a schematic structural diagram of a hybrid array tri-pathway vision sensor based on multi-scale spatiotemporal difference pixels according to the present application;

FIG. 6 is a schematic diagram of another multi-scale spatiotemporal difference according to the present application;

FIG. 7 is a circuit diagram of a multi-scale temporal difference according to the present application;

FIG. 8 is a circuit diagram of another multi-scale temporal difference according to the present application;

FIG. 9 is a circuit diagram of another multi-scale temporal difference according to the present application;

FIG. 10 is a circuit diagram of still another multi-scale temporal difference according to the present application;

FIG. 11 is a schematic structural diagram of a vision sensor chip based on an adaptive sampling technology according to the present application;

FIG. 12 is a first circuit diagram of a vision sensor chip based on an adaptive sampling technology according to the present application; and

FIG. 13 is a second circuit diagram of a vision sensor chip based on an adaptive sampling technology according to the present application.

### DETAILED DESCRIPTION

To illustrate objectives, solutions and advantages of the present application more clearly, the solutions in the present application will be described below clearly and completely in conjunction with the accompanying drawings in the present application. The described embodiments are part of the embodiments of the present application, rather than all of the embodiments. All other embodiments obtained by those skilled in the art based on the embodiments of the present utility model without any creative effort fall within the protection scope of the present application.

The traditional vision sensors obtain a temporal difference value by subtracting signal intensity of a pixel at a current time from signal intensity at the previous time, without taking into account the signal intensity at earlier times and thus the temporal correlation is relatively weak. Even if algorithmic processing can be performed in a subsequent stage by calculating the differences among signals from three different times, problems such as significant latency and high data transmission volume exist. If multi-scale difference processing is completed directly at a perceptive terminal of the sensor, this approach is expected to reduce the costs associated with backend processing and data transmission and to further improve the distribution of difference data and reveal richer temporal correlations within the signals regarding multi-scale differences.

The same principle applies to spatial difference values; from the perspective of convolutional neural networks, spatial differentiation mathematically behaves similarly to operations performed by convolutional layers. However, performing differentiation solely on adjacent pixels presents the problem of an overly small receptive field, making it impossible to observe spatial correlations between signals across larger distances. Therefore, it is necessary to introduce multi-scale spatial differentiation.

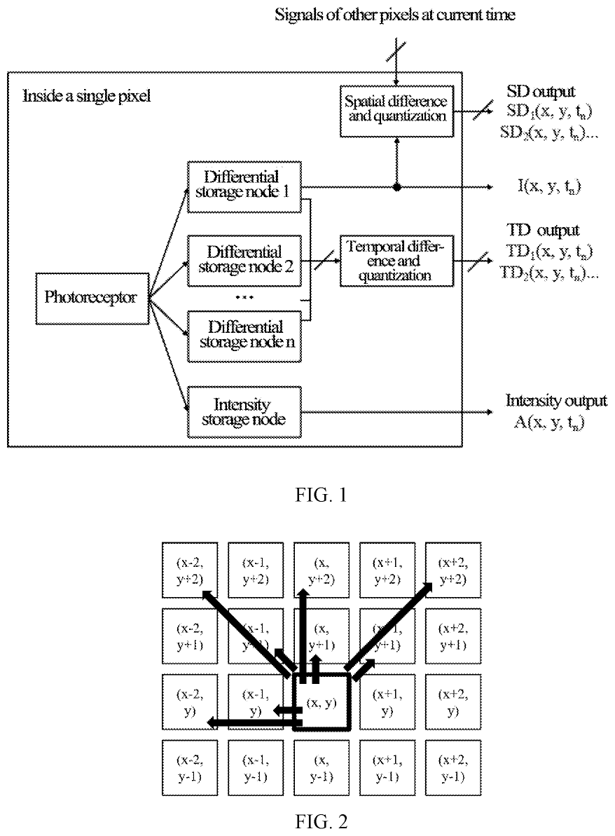

Reference is made to FIG. 1 and FIG. 1 is a schematic diagram of a multi-scale tri-multiplexed pixel according to the present application.

Reference is made to FIG. 2 and FIG. 2 is a schematic diagram of a unidirectionally extended multi-scale spatial difference according to the present application.

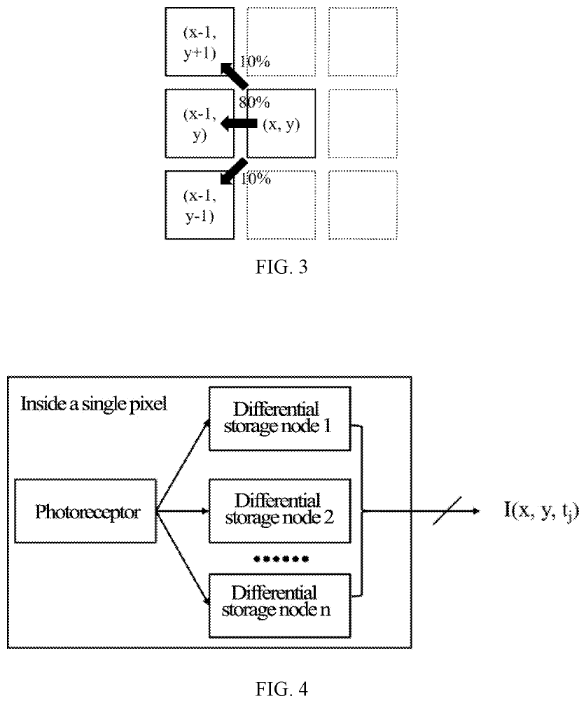

Reference is made to FIG. 3 and FIG. 3 is a schematic diagram of a freely extended multi-scale spatial difference according to the present application.

To solve the problems in the related art, according to the present application, there is provided a vision sensor chip based on a multi-scale spatiotemporal difference technology, including a pixel array including a plurality of pixels, at least one of a temporal difference (TD) pathway or a spatial difference (SD) pathway; where the temporal difference pathway is configured to perform weighted difference and quantization operations in a charge domain, an analog domain, or a digital domain on a signal at the position of a current pixel at a current time and a signal at the position of the current pixel at any previous time to obtain one or more types of multi-scale temporal difference value; and the spatial difference pathway is configured to perform weighted difference and quantization operations in the charge domain, the analog domain, or the digital domain on the signal at the position of the current pixel at the current time and a signal at a position of any spatial pixel at the current time to obtain one or more types of multi-scale spatial difference value.

The TD pathway of the present application outputs the temporal difference values at the position of the current pixel (x,y) across different times and the output from the TD pathway is expressed by the following equation:

$$TD ( x , y , {t}_{n} ) = {Q}_{TD} ( {\sum }_{i = 0}^{N} {α}_{i} I ( x , y , {t}_{n - i} ) )$$

where αᵢ represents a weighted value and αᵢ may be any numerical value. Q_{TD} represents a quantization method which may be multi-valued (>1 bit) or single-valued (positive or negative pulses). Times at which signals are obtained may be obtained through a full-array synchronization mode with a same time interval, full-array synchronization mode with a variable time interval or full-array synchronization mode.

The values of a; and the number N are not fixed; for example:

$$N = 2 , {a}_{0} = 1 , {a}_{1} = - 1 , TD ( x , y , {t}_{n} ) = {Q}_{TD} ( I ( x , y , {t}_{n} ) - I ( x , y , {t}_{n - 1} ) )$$

in this instance, the temporal difference process includes subtracting an output value at the previous time from the output value at the current time;

$$N = 3 , {a}_{0} = 1 , {a}_{1} = - 0.8 , {a}_{2} = - 0 \text{.2} ,$$

$$TD ( x , y , {t}_{n} ) = {Q}_{TD} ( I ( x , y , {t}_{n} ) - 80 \% I ( x , y , {t}_{n - 1} ) - 20 \% I ( x , y , {t}_{n - 2} ) )$$

$$N = 3 , {a}_{0} = 1 , {a}_{1} = 0.2 , {a}_{2} = - 1 \text{.2} ,$$

$$TD ( x , y , {t}_{n} ) = {Q}_{TD} ( I ( x , y , {t}_{n} ) + 20 \% I ( x , y , {t}_{n - 1} ) - 1 \; 20 \% I ( x , y , {t}_{n - 2} ) )$$

the operations of quantization and weighted difference are interchangeable; that is, the formula can also be expressed as:

$$T D ( x , y , {t}_{n} ) = {\sum }_{i = 0}^{N} {α}_{i} {Q}_{TD} ( I ( x , y , {t}_{n - i} ) )$$

multiple types of multi-scale temporal difference pathways may coexist simultaneously; for example:

$${TD}_{1} ( x , y , {t}_{n} ) = {Q}_{TD} ( {\sum }_{i = 0}^{N} {α}_{1 i} I ( x , y , {t}_{n - i} ) )$$

$${TD}_{2} ( x , y , {t}_{n} ) = {Q}_{TD} ( {\sum }_{i = 0}^{N} {α}_{2 i} I ( x , y , {t}_{n - i} ) )$$

and so on.

Furthermore, considering that the DVS outputs asynchronous information and output only timestamps and 1-bit data. Consequently, the DVS is susceptible to noise interference, possess low information density. Furthermore, the DVS cannot adapt to complex environments since the DVS is inherently limited to outputting only time-varying information in a 1-bit format. The vision sensing architecture of the present application requires the acquisition of temporal and spatial variations in visual signals through a synchronous or asynchronous mode and these temporal variations are preferably quantized and read out in a high-precision and multi-valued format.

The SD pathway outputs a spatial difference value between the position of the current pixel (x,y) and adjacent pixels (e.g., pixels provided diagonally or along the x-axis and y-axis) at the current time tₙ. For differences in the x and y directions, the outputs obtained from the SD pathways are expressed by the following equations:

$${SD}_{x} ( x , y , {t}_{n} ) = {Q}_{SD} ( {\sum }_{i = 0}^{M} {β}_{i} I ( x - i , y , {t}_{n} ) )$$

$${SD}_{y} ( x , y , {t}_{n} ) = {Q}_{SD} ( {\sum }_{i = 0}^{M} {γ}_{i} l ( x , y - i , {t}_{n} ) )$$

for diagonal differences, the outputs obtained from the spatial difference pathways are expressed by the following equations:

$$S {D}_{↙} ( x , y , {t}_{n} ) = {Q}_{SD} ( {\sum }_{i = 0}^{M} {β}_{i} I ( x - i , y - i , {t}_{n} ) )$$

$$S {D}_{↘} ( x , y , {t}_{n} ) = {Q}_{SD} ( {\sum }_{i = 0}^{M} {γ}_{i} I ( x + i , y - i , {t}_{n} ) )$$

where Q_{SD} represents a quantization method; this method may be multi-valued (>1 bit) or single-valued (positive or negative pulses). Times at which signals are obtained, tₙ, tₙ₋₁, tₙ₋₂, . . . may be obtained through a full-array synchronization mode with same time intervals, full-array synchronization mode with a variable time interval or full-array synchronization mode.

The aforementioned multi-scale spatial difference approach is intended to be extended along a specific direction.

In a more generalized form, the spatial difference can be expressed as:

$${SD}_{*} ( x , y , {t}_{n} ) = {Q}_{SD} ( {\sum }_{i = 0}^{M} {λ}_{i} I ( {x}_{n} , {y}_{n} , {t}_{n} ) )$$

the subscript * in SD serves to indicate that SD may exist across multiple dimensions—for instance, SDₓ, SD_{y}, [symbol] , and [symbol] . This generalized formula can be used to represent more complex scenarios:

$${SD}_{x}^{′} ( x , y , {t}_{n} ) = {Q}_{SD} ( I ( x , y , {t}_{n} ) - 80 \% I ( x - 1 , y , {t}_{n} ) - 10 \% I ( x - 1 , y + 1 , {t}_{n} ) - 10 \% I ( x - 1 , y - 1 , {t}_{n} ) )$$

all signals mentioned in above pathways are three-dimensional quantities, including two spatial dimensions x and y and one temporal dimension t.

The number of temporal difference pathways and spatial difference pathways may be one or multiple and there is no specific limitation thereto herein.

By extending the temporal difference and the spatial difference to a multi-scale mode, the present application facilitates the analysis of the spatiotemporal correlation of signals and provides a larger spatiotemporal receptive field.

Based on the embodiment above, reference is made to FIG. 4 and FIG. 4 is a schematic diagram of a spatiotemporal difference pixel satisfying multi-scale TD and SD output requirements according to the present application.

In an embodiment, the temporal difference pathway includes a plurality of temporally differential storage nodes, a temporal differentiator, and a temporal quantizer; the plurality of temporally differential storage nodes are configured to store electrical signals at the position of the current pixel at a plurality of different times, respectively; and the temporal differentiator is configured to perform weighted temporal difference operation on the electrical signal at the position of the current pixel at the current time and the electrical signal at the position of the current pixel at any previous time based on the electrical signals at the position of the current pixel at the plurality of different times to obtain the multi-scale temporal difference values, where analog-to-digital signal conversion is performed by the temporal quantizer during the multi-scale temporal difference process; the spatial difference pathway includes a spatially differential storage node multiplexed with one of the plurality of temporally differential storage nodes, a spatial differentiator, and a spatial quantizer; the spatially differential storage node is configured to store the electrical signal at the position of the current pixel at the current time; and the spatial differentiator is configured to perform weighted spatial difference operation on the electrical signal at the position of the current pixel at the current time and an electrical signal at the position of any spatial pixel at the current time to obtain multi-scale spatial difference values, where analog-to-digital signal conversion is performed by the spatial quantizer.

Quantization modes used by both the temporal differentiator and quantizer and the spatial differentiator and quantizer may be either multi-valued (>1 bit) or single-valued (positive and negative pulses). Times at which signals are obtained may be obtained through a full-array synchronization mode with same time intervals, full-array synchronization mode with a variable time interval or full-array synchronization mode.

In the field of digital signal processing, quantization mainly refers to a process of converting analog signals into digital signals. Sampling and quantization of signals are typically performed by an analog-to-digital converter (ADC).

In an embodiment, at least one of the temporal differentiator or the temporal quantizer is provided inside the pixel, and uses a pixel-level signal readout mode; or at least one of the temporal differentiator or the temporal quantizer is provided outside the pixel and shared by pixels located in a same column and uses a column-level signal readout mode; at least one of the spatial differentiator or the spatial quantizer is provided inside the pixel and uses a pixel-level signal readout mode; or at least one of the spatial differentiator or the spatial quantizer is provided outside the pixel and shared by pixels located in the same column and uses a column-level signal readout mode.

In the present embodiment, if the temporal differentiator and the spatial differentiator are provided outside the spatiotemporal difference pixels and all spatiotemporal difference pixels within a given column share a same temporal differentiator and a same spatial differentiator, the readout of temporal difference values and spatial difference values of the plurality of spatiotemporal difference pixels need be performed simultaneously. This readout process follows a specific rule and the information may be output at several fixed times (e.g., tₙ, tₙ₋₁, tₙ₋₂, etc.). These times may be spaced at fixed intervals, or may be configured as adaptive, programmable, and variable intervals; reducing the total number of quantizers required and lowering hardware resource consumption.

If the temporal differentiator and the spatial differentiator are provided within the spatiotemporal difference pixels, the temporal difference values and spatial difference values of the spatiotemporal difference pixels may be read out using either a full-array synchronous mode or a full-array asynchronous mode. Specifically, in the asynchronous mode, the spatiotemporal difference values and spatial difference values are output based on a specific trigger time of each individual spatiotemporal difference pixel, enhancing flexibility and reducing output latency.

In an embodiment, the arrangement of the temporal differentiator and the spatial differentiator within the vision sensor chip of the present application, whether provided inside or outside the pixels, may be combined in any arbitrary manner and there is no special limitation thereto in the present application.

In an embodiment, each pixel of the pixel array is provided with a pulse generator; or all pixels in the pixel array are collectively connected to a single pulse generator; or the pixel array is partitioned into a plurality of sub-regions and all pixels in each sub-region are collectively connected to a single pulse generator; where the pulse generator is configured to generate a trigger signal at a fixed time interval, or at adaptive, programmable, and variable intervals to control a start exposure time and an exposure duration of a photoreceptor; pixels connected to a same pulse generator perform synchronous exposure, and pixels connected to different pulse generators perform either synchronous or asynchronous exposure; where the photoreceptor is provided inside the pixel and is configured to convert a photosignal received at the position of the current pixel into an analog electrical signal. A column-level readout method is used in the present embodiment.

In the present embodiment, two readout modes, that is, a full-array synchronization mode with same time intervals and a full-array synchronization mode with a variable time interval may be used.

The synchronization pulses can be generated not only at fixed time intervals but also at adaptive, programmable variable intervals. Such adaptive intervals may adapt the dynamic characteristics of external visual signals; specifically, a higher sampling frequency is used in case that the magnitude of change or the frequency of variation is high, whereas a lower sampling frequency is used for low-frequency signals, reducing both data volume and power consumption.

The present application includes at least one of the temporal difference pathway or the spatial difference pathway, that is, solely the temporal difference pathway, or solely the spatial difference pathway, or both the temporal difference pathway and the spatial difference pathway simultaneously.

The present application further supports a configuration where a plurality of pixels constitutes a single macroblock to share an intra-pixel pulse generator, reducing the complexity of the chip design and minimize an occupied area of the chip.

In an embodiment, an exposure mode for each pixel of the pixel array is a global shutter or a rolling shutter.

Exposure mode, whether global or rolling used by the temporal difference pathway, and the spatial difference pathway may be combined in any arbitrary manner and there is no specific limitation thereto herein.

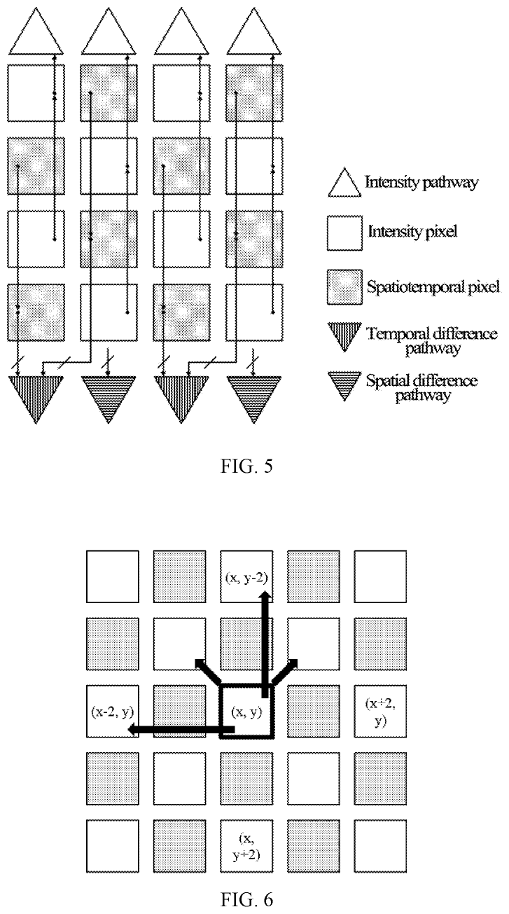

Reference is made to FIG. 5 and FIG. 5 is a schematic structural diagram of a hybrid array tri-pathway vision sensor based on multi-scale spatiotemporal difference pixels according to the present application.

According to the present application, there is further provided a multi-pathway vision sensor chip based on a multi-scale spatiotemporal difference technology, including a pixel array, an intensity pathway and at least one of a temporal difference pathway or a spatial difference pathway and the pixel array includes a plurality of pixels; where the intensity pathway is configured to determine a quantized value of an electrical signal converted from intensity of incident light at a position of a current pixel at a current time; the temporal difference pathway is configured to perform weighted difference and quantization operations in a charge domain, an analog domain, or a digital domain on a signal at the position of a current pixel at a current time and a signal at the position of the current pixel at any previous time to obtain one or more types of multi-scale temporal difference value; and the spatial difference pathway is configured to perform weighted difference and quantization operations in the charge domain, the analog domain, or the digital domain on the signal at the position of the current pixel at the current time and a signal at a position of any spatial pixel at the current time to obtain one or more types of multi-scale spatial difference value.

From the perspective of visual primitives, traditional CMOS image sensor (CIS) and DVS vision sensors suffer from incomplete acquisition of information. For example, in case that a scene contains large-scale flashes or undergoes drastic changes in light intensity, all TD pixels simultaneously output events, leading to saturation. Consequently, the DVS pathway is unable to output valid information, while the CIS pathway is likewise unable to respond in real time due to be constrained by its frame rate. Such extreme scenarios are highly prevalent in autonomous driving environments and are critical to driving safety, for examples, the scenarios include entering or exiting tunnels, or encountering flashes from traffic enforcement cameras at night. In contrast, a human visual system whether at high noon or at dusk, and whether operating in an open environment or a partially occluded scene is capable of rapidly identifying moving targets. A level of robustness and versatility far exceeding that of the traditional DAVIS is achieved. This superior performance stems from the fact that, in addition to intensity and temporal difference pathways, the human eye also possesses a spatial difference pathway; these three pathways integrate organically to form distinct visual primitives, generating highly efficient and robust visual representations.

Inspired by human vision, a spatial difference (SD) pathway—analogous to that found in the human retina is added into traditional solutions based on single-pixel multiplexing or hybrid pixel arrays according to the present application. The vision sensor simultaneously provides three different outputs: an intensity output, a TD output, and an SD output.

The intensity pathway of the present application outputs an electrical signal of intensity I(x,y,tₙ) of incident light at a position of a current pixel (x,y) at a current time tₙ, that is,

$$A ( x , y , {t}_{n} ) = {Q}_{A} ( I ( x , y , {t}_{n} ) )$$

Q_{A} represents a quantization method used by the intensity pathway.

The TD pathway of the present application outputs the temporal difference values at the position of the current pixel (x,y) across different times and the output from the TD pathway is expressed by the following equation:

$$TD ( x , y , {t}_{n} ) = {Q}_{TD} ( {\sum }_{i = 0}^{N} {α}_{i} I ( x , y , {t}_{n - i} ) )$$

where αᵢ represents a weighted value and αᵢ may be any numerical value. Q_{TD} represents a quantization method; this method may be multi-valued (>1 bit) or single-valued (positive or negative pulses). Times at which signals are obtained, tₙ, tₙ₋₁, tₙ₋₂, . . . may be obtained through a full-array synchronization mode with a same time interval, full-array synchronization mode with a variable time interval or full-array synchronization mode.

The values of αᵢ and the number N are not fixed; for example:

$$N = 2 , {a}_{0} = 1 , {a}_{1} = - 1 , TD ( x , y , {t}_{n} ) = {Q}_{TD} ( I ( x , y , {t}_{n} ) - I ( x , y , {t}_{n - 1} ) )$$

in this instance, the temporal difference process includes subtracting an output value at the previous time from the output value at the current time;

$$N = 3 , {a}_{0} = 1 , {a}_{1} = - 0 \text{.8} , {a}_{2} = - 0 \text{.2} ,$$

$$TD ( x , y , {t}_{n} ) = {Q}_{TD} ( I ( x , y , {t}_{n} ) - 80 \% I ( x , y , {t}_{n - 1} ) - 20 \% I ( x , y , {t}_{n - 2} ) )$$

$$N = 3 , {a}_{0} = 1 , {a}_{1} = 0.2 , {a}_{2} = - 1.2 ,$$

$$TD ( x , y , {t}_{n} ) = {Q}_{TD} ( I ( x , y , {t}_{n} ) + 20 \% I ( x , y , {t}_{n - 1} ) - 120 \% I ( x , y , {t}_{n - 2} ) )$$

the operations of quantization and weighted difference are interchangeable; that is, the formula can also be expressed as:

$$TD ( x , y , {t}_{n} ) = {\sum }_{i = 0}^{N} {α}_{i} {Q}_{TD} ( I ( x , y , {t}_{n - i} ) )$$

multiple types of multi-scale temporal difference pathways may coexist simultaneously; for example:

$${TD}_{1} ( x , y , {t}_{n} ) = {Q}_{TD} ( {\sum }_{i = 0}^{N} {α}_{1 i} I ( x , y , {t}_{n - i} ) )$$

$${TD}_{2} ( x , y , {t}_{n} ) = {Q}_{TD} ( {\sum }_{i = 0}^{N} {α}_{2 i} I ( x , y , {t}_{n - i} ) )$$

and so on.

Furthermore, considering that the DVS outputs asynchronous information and output only timestamps and 1-bit data. Consequently, the DVS is susceptible to noise interference, possess low information density. Furthermore, the DVS cannot adapt to complex environments since the DVS is inherently limited to outputting only time-varying information in a 1-bit format. The vision sensing architecture of the present application requires the acquisition of temporal and spatial variations in visual signals through a synchronous or asynchronous mode and these temporal variations are preferably quantized and read out in a high-precision and multi-valued format.

The spatial difference pathway outputs the spatial difference value between a position of the current pixel (x, y) and a position of any other spatial pixel (e.g., pixels provided diagonally or along the x-axis and y-axis) at the current time tₙ. For differences in the x and y directions, the outputs obtained from the SD pathways are expressed by the following equations:

$${SD}_{x} ( x , y , {t}_{n} ) = {Q}_{SD} ( {\sum }_{i = 0}^{M} {β}_{i} I ( x - i , y , {t}_{n} ) )$$

$${SD}_{y} ( x , y , {t}_{n} ) = {Q}_{SD} ( {\sum }_{i = 0}^{M} {γ}_{i} I ( x , y - i , {t}_{n} ) )$$

for diagonal differences, the outputs obtained from the spatial difference pathways are expressed by the following equations:

$${SD}_{↙} ( x , y , {t}_{n} ) = {Q}_{SD} ( {\sum }_{i = 0}^{M} {β}_{i} I ( x - i , y - i , {t}_{n} ) )$$

$${SD}_{↘} ( x , y , {t}_{n} ) = {Q}_{SD} ( {\sum }_{i = 0}^{M} {γ}_{i} I ( x + i , y - i , {t}_{n} ) )$$

where Q_{SD} represents a quantization method, which may be multi-valued (>1 bit) or single-valued (positive or negative pulses). Times at which signals are obtained, tₙ, tₙ₋₁, tₙ₋₂, . . . may be obtained through a full-array synchronization mode with a same time interval, full-array synchronization mode with a variable time interval or full-array synchronization mode.

The aforementioned multi-scale spatial difference approach is intended to be extended along a specific direction.

In a more generalized form, the spatial difference can be expressed as:

$${SD}_{*} ( x , y , {t}_{n} ) = {Q}_{SD} ( {\sum }_{i = 0}^{M} {λ}_{i} I ( {x}_{n} , {y}_{n} , {t}_{n} ) )$$

here, the subscript * in SD serves to indicate that SD may exist across multiple dimensions—for instance, SDₓ, SD_{y}, [symbol] , and [symbol] . This generalized formula can be used to represent more complex scenarios:

$${SD}_{x}^{′} ( x , y , {t}_{n} ) = {Q}_{SD} ( I ( x , y , {t}_{n} ) - 80 \% I ( x - 1 , y , {t}_{n} ) - 10 \% I ( x - 1 , y + 1 , {t}_{n} ) - 10 \% I ( x - 1 , y - 1 , {t}_{n} ) )$$

all signals mentioned in above pathways are three-dimensional quantities, including two spatial dimensions x and y and one temporal dimension t.

In an embodiment, the pixel array includes a single type of pixel provided with an intensity pathway, and at least one of a temporal difference pathway or a spatial difference pathway corresponding to the single type of pixel; or the pixel array includes two types of pixels, where a first type of pixel is provided with an intensity pathway, and a second type of pixel is provided with at least one of a temporal difference pathway or spatial difference pathway.

The intensity pathway, the temporal difference pathway, and/or spatial difference pathways involved in the present application means that the sensor chip may include the intensity pathway and the temporal difference pathway; or include the intensity pathway and the spatial difference pathways; or include the intensity pathway and both the temporal difference pathway and the spatial difference pathway.

In case that the chip includes the intensity pathway and the temporal difference pathways, the pixel array of the chip may consist entirely of a single type of pixel that simultaneously corresponds to both the intensity pathway and the temporal difference pathway; or the pixel array of the chip may also consist of two types of pixels, where a first type of pixel corresponds to the intensity pathway and the second type of pixel corresponds to the temporal difference pathway; or the pixel array of the chip may simultaneously include three types of pixels, where the first type of pixel corresponds to the intensity pathway, the second type of pixel corresponds to the temporal difference pathway, and the third type of pixel corresponds to both the intensity pathway and the temporal difference pathway.

In case that the chip includes the intensity pathway and the spatial difference pathways, the pixel array of the chip may consist entirely of a single type of pixel that simultaneously corresponds to both the intensity pathway and the spatial difference pathway; or the pixel array of the chip may also consist of two types of pixels, where a first type of pixel corresponds to the intensity pathway and the second type of pixel corresponds to the spatial difference pathway; or the pixel array of the chip may also consist of three types of pixels, where the first type of pixel corresponds to the intensity pathway, the second type of pixel corresponds to the spatial difference pathway, and the third type of pixel corresponds to both the intensity pathway and the spatial difference pathway.

In case that the chip includes the intensity pathway, the temporal difference pathway, and the spatial difference pathway, i.e., a tri-pathway chip, the pixel array of the chip may consist entirely of a single type of pixel that simultaneously corresponds to the intensity pathway, the temporal difference pathway and the spatial difference pathway; or the pixel array of the chip may also consist of two types of pixels where a first type of pixel corresponds to the intensity pathway and the second type of pixel corresponds to the temporal difference pathway and the spatial difference pathway; or the pixel array of the chip may also consist of two types of pixels where a first type of pixel corresponds to the temporal difference pathway and the second type of pixel corresponds to the intensity pathway and the spatial difference pathway; or the pixel array of the chip may also consist of two types of pixels where a first type of pixel corresponds to the spatial difference pathway and the second type of pixel corresponds to the temporal difference pathway and the intensity pathway; or the pixel array of the chip may also consist of three types of pixels, where the first type of pixel corresponds to the intensity pathway, the second type of pixel corresponds to the spatial difference pathway, and the third type of pixel corresponds to the spatial difference pathway. Moreover, the pixel array may also include any combination of types of the pixel mentioned above as long as requirements that at least one type of pixel provides an intensity pathway output, at least one type of pixel provides a temporal difference pathway output, and at least one type of pixel provides a spatial difference pathway output are satisfied.

A tri-pathway vision sensor chip may use a single-pixel multiplexing mode (i.e., the pixel array contains only one type of pixel), a hybrid pixel array mode (i.e., the pixel array contains multiple types of pixels), or a combination of both modes. Specifically, the configurations include:
a tri-output multiplexed pixel (intensity, TD, SD);
a dual-input multiplexed pixel (intensity, TD) paired with an SD pixel, forming a binary hybrid array;
a dual-input multiplexed pixel (intensity, SD) paired with a TD pixel, forming a binary hybrid array;
a dual-input multiplexed pixel (TD, SD) paired with an intensity pixel, forming a binary hybrid array; and
a TD pixel, an SD pixel and an intensity pixel independently forming a ternary hybrid array.

In an embodiment; the intensity pathway includes an intensity storage node and an intensity quantizer, where the intensity storage node is configured to store the electrical signal converted from the intensity of the incident light at the position of the current pixel at the current time and the intensity quantizer is configured to perform analog-to-digital conversion on the electrical signal converted from the intensity of the incident light at the position of the current pixel at the current time to obtain a quantized value of the electrical signal converted from the intensity of the incident light at the position of the current pixel at the current time; the temporally difference pathway includes a plurality of temporally differential storage nodes, a temporal differentiator, and a temporal quantizer, where the plurality of temporally differential storage nodes are configured to store electrical signals at the position of the current pixel at a plurality of different times, respectively; and the temporal differentiator is configured to perform weighted temporal difference operation on the electrical signal at the position of the current pixel at the current time and the electrical signal at the position of the current pixel at any previous time based on the electrical signals at the position of the current pixel at the plurality of different times to obtain multi-scale temporal difference values, where analog-to-digital signal conversion is performed by the temporal quantizer during the multi-scale temporal difference process; the spatial difference pathway includes a spatially differential storage node multiplexed with one of the plurality of temporally differential storage nodes, a spatial differentiator, and a spatial quantizer; the spatially differential storage node is configured to store the electrical signal at the position of the current pixel at the current time; and the spatial differentiator is configured to perform weighted spatial difference operation on the electrical signal at the position of the current pixel at the current time and an electrical signal at the position of any spatial pixel at the current time to obtain multi-scale spatial difference values, where analog-to-digital signal conversion is performed by the spatial quantizer.

The present embodiment uses a full-array asynchronous mode. Based on the intensity output and the TD output of a multiplexed pixel, a type of an output from a temporally differential storage node is added in the present embodiment and is used for the SD output. That is, by connecting the temporally differential storage nodes of adjacent pixels to the spatial differentiator, the final SD output can be obtained. The square symbol represents a “tri-multiplexed pixel” and the arrows indicate the transfer of I(x,y,tₙ) information. This pixel supports the multi-scale spatiotemporal difference operations described in the present embodiment, while simultaneously supporting output of the intensity pathway. The present embodiment does not provide a diagram of arrangement of the pixel array. The diagram of arrangement of the pixel array should consist of closely packed rectangles, and the interconnections between the rectangles are determined by I(x,y,tₙ) requiring transfer between pixels.

The vision sensor chip of the present application may also use a full-array synchronization scheme; the tri-pathway vision system of the present application includes binary hybrid pixels; specifically, these binary hybrid pixels incorporate not only intensity pixels but also integrate SD and TD capabilities within the same pixel, referred to herein as multi-scale spatiotemporal difference pixels. The precise interconnection configuration is not explicitly detailed here since the specific interconnection relationship is determined based on the particularly used multi-scale difference method.

Reference is made to FIG. 6 and FIG. 6 is a schematic diagram of another multi-scale spatiotemporal difference according to the present application.

Furthermore, during multi-scale operations, spatial difference outputs in the x and y directions can be obtained by spanning a distance of one intensity pixel in the respective direction. That is Q_{SD}(I(x,y,tₙ)−I(x−2,y,tₙ)). Moreover, theoretically, the chip can support difference results in any arbitrary direction—for example, Q_{SD}(I(x,y,tₙ)−I(x−1,y+3,tₙ)), which obtains a spatial difference result corresponding to an angle of arctan (3).

It should be noted that the arrangement of spatiotemporal difference pixels relative to intensity pixels may take the form of any arbitrary combination and there is no specific limitation thereto herein.

According to the present application, there is provided a tri-pathway vision sensor chip architecture capable of simultaneously generating intensity outputs, temporal difference outputs, and spatial difference outputs, and there is further provided various different implementation methods for the pixels and arrays, enhancing the perceptual capabilities of traditional multiplexed pixels and hybrid-array sensors, expanding their range of application scenarios, and contributing to improving the robustness of vision sensors in applications such as autonomous driving. Furthermore, the tri-pathway vision sensor provides a feasible implementation solution for theories regarding visual-primitive-based representations.

In an embodiment, the intensity quantizer is provided inside the pixel, and uses a pixel-level signal readout mode; alternatively, the intensity quantizer is provided outside the pixel and shared by pixels located in the same column and uses a column-level signal readout mode; at least one of the temporal differentiator or the temporal quantizer is provided inside the pixel and uses a pixel-level signal readout mode; or at least one of the temporal differentiator or the temporal quantizer is provided outside the pixel and shared by pixels located in the same column and uses a column-level signal readout mode; at least one of the spatial differentiator or the spatial quantizer is provided inside the pixel, and uses a pixel-level signal readout mode; or at least one of the spatial differentiator or the spatial quantizer is provided outside the pixel and shared by pixels located in the same column and uses a column-level signal readout mode.

In the present embodiment, if the temporal differentiator and the spatial differentiator are provided outside the spatiotemporal difference pixels and all spatiotemporal difference pixels within a given column share a same temporal differentiator and a same spatial differentiator, the readout of temporal difference values and spatial difference values of the plurality of spatiotemporal difference pixels need be performed simultaneously. This readout process follows a specific rule and the information may be output at several fixed times (e.g., tₙ, tₙ₋₁, tₙ₋₂, . . . ). These times may be spaced at fixed intervals, or may be configured as adaptive, programmable, and variable intervals; reducing the total number of quantizers required and lowering hardware resource consumption.

If the temporal differentiator and the spatial differentiator are provided within the spatiotemporal difference pixels, the temporal difference values and spatial difference values of the spatiotemporal difference pixels may be read out using either a full-array synchronous mode or a full-array asynchronous mode. In the asynchronous mode, the spatiotemporal difference values and spatial difference values are output based on a specific trigger time of each individual spatiotemporal difference pixel, enhancing flexibility and reducing output latency.

In an embodiment, the arrangement of the intensity quantizer being provided outside the intensity pixel and the temporal differentiator and the spatial differentiator being provided inside or outside the spatiotemporal difference pixel may be arbitrarily combined in the visual sensor chip of the present application; and there is no special limitation thereto in the present application.

The vision sensor of the present application is a vision sensor featuring multi-scale temporal difference and multi-scale spatial difference. A circuit structure of the vision sensor is described below by taking the multi-scale temporal difference as an illustrative example. By analogy, the circuit structure of a vision sensor featuring multi-scale spatial difference can be similarly derived and there is no specific limitation thereto herein.

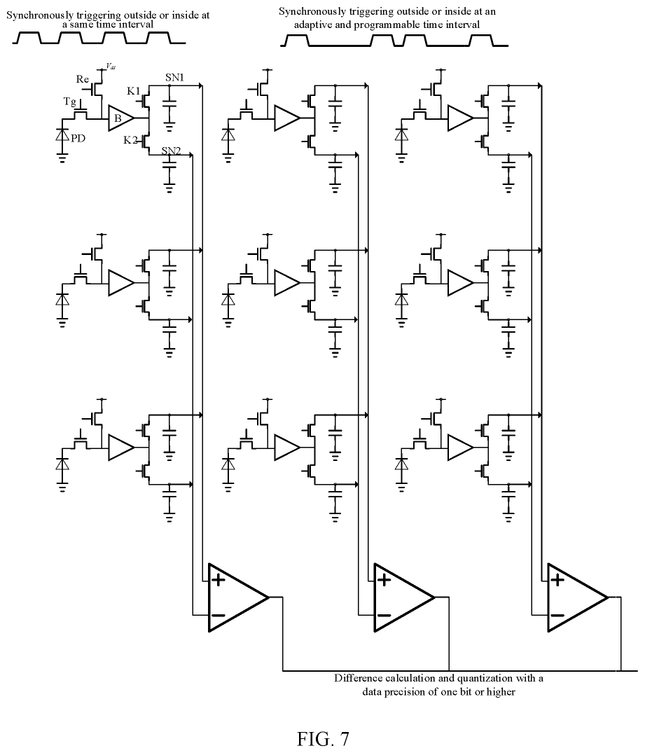

Reference is made to FIG. 7 and FIG. 7 is a schematic diagram of a multi-scale temporal difference according to the present application.

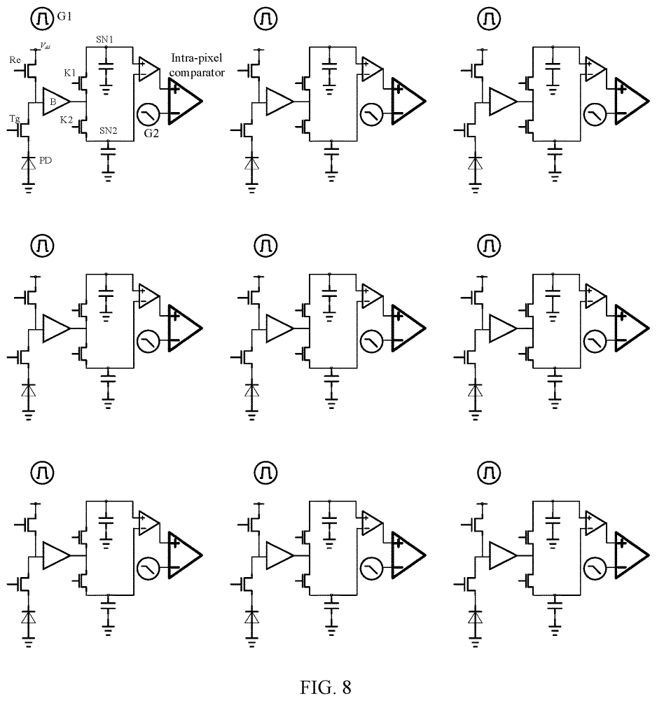

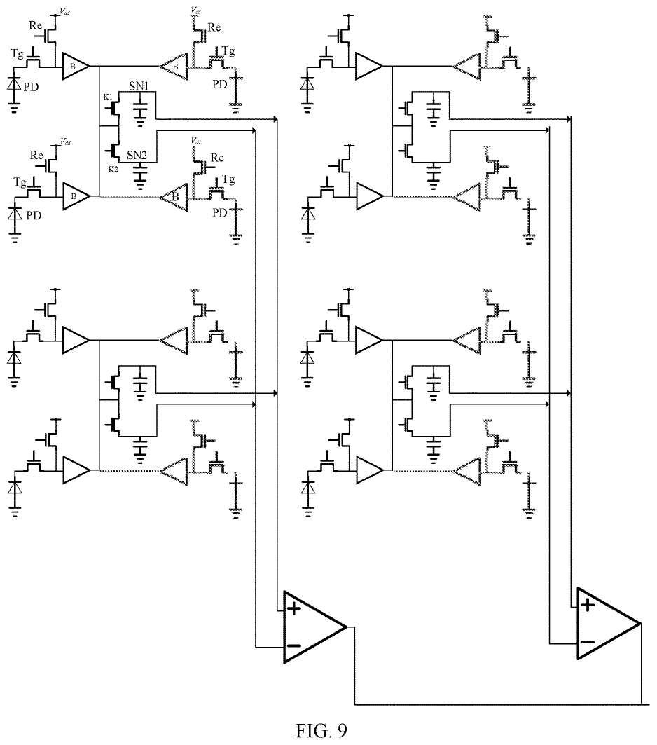

Reference is made to FIG. 8 and FIG. 8 is a schematic diagram of another multi-scale temporal difference according to the present application.

Definitions of symbols for electrical components shown in FIG. 7 to FIG. 10 and FIG. 12 are listed below:

PD denotes a photodiode; Tg denotes a transfer switch transistor; Re denotes a reset switch transistor; B denotes a buffer; K1 denotes switch 1; K2 denotes switch 2; SN1 denotes storage node 1; SN2 denotes storage node 2; Vdd denotes supply voltage; G1 denotes an intra-pixel trigger pulse generator; G2 denotes an intra-pixel ramp generator and J denotes a differential comparator. The symbols for electrical components are not labeled again elsewhere.

A sensor provided solely with a multi-scale temporal difference pathway is involved in the present embodiment. Based on this structure, a circuit structure of a sensor provided solely with a multi-scale spatial difference pathway, as well as a circuit structure of other multi-scale dual- or tri-pathway sensor can also be derived.

The present application further implements an architecture of a high-precision, multi-value, time-varying vision sensor chip featuring a full-array asynchronous form. The present chip implements self-triggering (supporting internal or external triggering, which is programmable and adaptive), signal storage, intra-pixel temporal signal difference, and quantized readout within single pixel; and each pixel directly outputs high-precision, multi-valued temporal difference signals (with a precision of ≥2 bit).

The chip supports global asynchronous operation, where each pixel is provided with a dedicated control logic. The control logic, referred to as an intra-pixel pulse generator, is capable of adaptively adjusting a time at which calculating temporal difference visual signals is triggered based on a light intensity level perceived by the pixel. Since the trigger time varies for each pixel, this mechanism constitutes the implementation of the global asynchronous operation.

In an embodiment, each pixel of the pixel array is provided with a pulse generator; or all pixels in the pixel array are collectively connected to one pulse generator; or the pixel array is partitioned into a plurality of sub-regions and all pixels in each sub-region are collectively connected to one pulse generator; where the pulse generator is configured to generate a trigger signal at a fixed time interval, or at adaptive, programmable, and variable intervals to control a start exposure time and an exposure duration of a photosensitive element; pixels connected to a same pulse generator perform synchronous exposure, and pixels connected to different pulse generators perform either synchronous or asynchronous exposure; where the photosensitive element is provided inside the pixel and is configured to convert a light signal received at the position of the current pixel into an analog electrical signal.

In the present embodiment, two readout modes, that is, a full-array synchronization mode with a same time interval and a full-array synchronization mode with a variable time interval may be used.

The synchronization pulses can be generated not only at fixed time intervals but also at adaptive, programmable variable intervals. Such adaptive intervals may adapt the dynamic characteristics of external visual signals; specifically, a higher sampling frequency is used in case that the magnitude of change or the frequency of variation is high, whereas a lower sampling frequency is used for low-frequency signals, reducing both data volume and power consumption.

The chip of present application includes at least one of the intensity pathway, the temporal difference pathway or the spatial difference pathway. That is, the chip may include solely the temporal difference pathway, solely the spatial difference pathway, or solely the intensity pathway; or may include both the intensity pathway and the temporal difference pathway, or both the intensity pathway and the spatial difference pathway, or both the temporal difference pathway and the spatial difference pathway, or all the intensity pathway, the temporal difference pathway, and the spatial difference pathway.

The present application further supports a configuration where a plurality of pixels constitutes single macroblock to share an intra-pixel pulse generator, reducing the complexity of the chip design and minimize an occupied area of the chip.

Reference is made to FIG. 9 and FIG. 9 is a schematic diagram of another multi-scale temporal difference according to the present application.

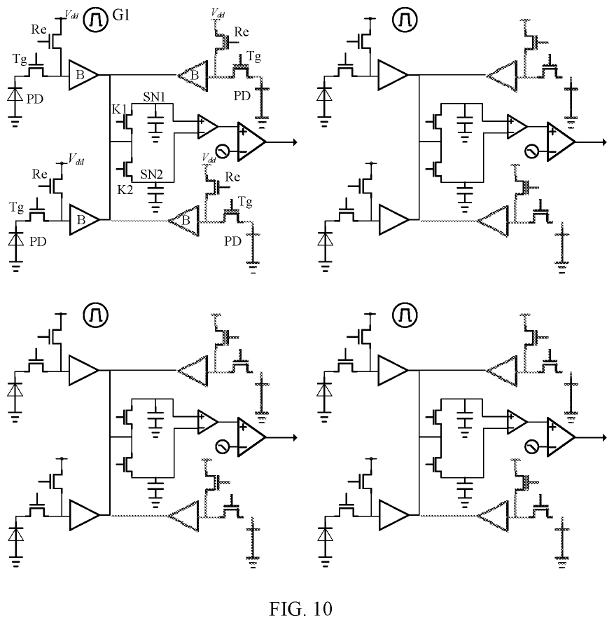

Reference is made to FIG. 10 and FIG. 10 is a schematic diagram of another multi-scale temporal difference according to the present application.

The vision sensor chip of the present application may support pixel-space binning to enable temporal difference sensing characterized by a larger receptive field, a broader spatial scale, and higher sensitivity. By sharing readout switches and storage nodes, electrical signals of the plurality of pixels are binned together and temporal difference calculations are performed.

The present application provides a multi-valued and high-precision visual sensor chip architecture capable of obtaining temporal variations, and introduces various signal recording and conversion methods, significantly enhancing capability of the visual sensor chip to perform high-precision reconstruction of spatiotemporal dynamic information.

A fundamental operating principle of currently mainstream image sensors is based on frame-by-frame capture and video recording and is typically implemented through active pixel sensor (APS). The APS are capable only of processing color images arranged in a pixel-matrix frame format, offer advantages such as high color fidelity, high resolution, and superior image quality and a disadvantage of comparatively slow capture speeds due to relatively limited dynamic range of the acquired image signals.

An event camera, also referred to as a dynamic vision sensor (DVS), is a novel type of imaging system. Unlike traditional cameras employing a shutter to control the frame rate and recording light intensity across all pixels on a per-frame basis, the event camera is sensitive to the rate of change in light intensity. Each pixel independently records the logarithmic change in light intensity at its specific location; and the pixel generates either a positive or a negative pulse in case that this change is greater than a predetermined threshold. The event camera is not controlled by the shutter due to asynchronous characteristic and thus has exceptionally high temporal resolution (Frame rate: approximately 1,000,000 fps; while the frame rate of traditional cameras is about 100 fps). in case that combined with its inherent sensitivity to change, the DVS naturally adapts to tasks such as motion detection.

The DVS outputs asynchronous information and only timestamps and 1-bit data. Consequently, DVS is susceptible to noise interference, possesses low information density, and exhibit a low signal-to-noise ratio (SNR). Furthermore, the DVS is prone to encountering a case where the generalized sampling theorem is not satisfied and cannot adapt to complex environments since the DVS is inherently limited to outputting only time-varying information in a 1-bit format.

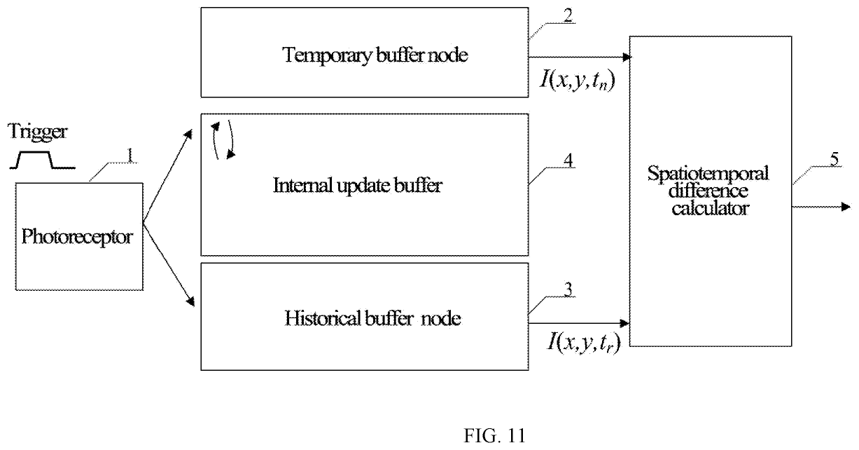

Reference is made to FIG. 11 and FIG. 11 is a schematic structural diagram of a vision sensor chip based on an adaptive sampling technology according to the present application.

To solve the problem in the related art, according to the present application, there is provided a vision sensor chip based on an adaptive sampling technology, including a plurality of pixels, an internal update buffer 4, and a spatiotemporal difference calculator 5; where each of the plurality of pixels is provided with a photoreceptor 1 and a calculation signal buffer including a temporary buffer node 2 and a historical buffer node 3, where the photoreceptor 1 is configured to determine an electrical signal at a position of a current pixel, the electrical signal includes a temporary signal and a historical signal; the calculation signal buffer is configured to output a calculation signal in case that a calculation condition is satisfied, and to not output the calculation signal in case that the calculation condition is not satisfied, the calculation condition is that a difference value between the temporary signal and the historical signal is greater than a preset threshold, the calculation signal is a signal for difference calculation in a sampling selection mode being either an adaptive sampling mode or a non-adaptive sampling mode, the temporary signal is stored in the temporary buffer node 2, and the historical signal is stored in the historical buffer node 3; the internal update buffer 4 is configured to update the historical signal with the temporary signal in the adaptive sampling mode and in case that the calculation condition is satisfied and not to update the historical signal in the adaptive sampling mode and in case that the calculation condition is not satisfied and update the historical signal with the temporary signal during every sampling in the non-adaptive sampling mode; and the spatiotemporal difference calculator 5 is configured to determine a spatiotemporal difference value based on the calculation signal.

A human visual system can simultaneously perceive both temporal and spatial variations, making it more sensitive and robust to the outside world. Inspired by human vision, according to the present application, there is provided a vision sensor capable of adaptively adjusting its temporal sampling rate. The sensor implements a passive adaptation of the sampling rate at the level of individual pixels, pixel macroblocks, or pixel clusters to actively adapt to a velocity of external motion. To obtain accurate motion fields and visual features, according to the present application, there is provided a pixel architecture, array configuration, and readout mode specifically designed for the sensor based on the aforementioned adaptive-sampling-rate pixels.

The photoreceptor 1 captures a photosignal of the position of the current pixel and performs optoelectronic conversion on the photosignal to generate an electrical signal denoted as I(x,y,t) including a temporary signal I(x,y,tᵣ) and a historical signal I(x,y,tₙ).

Subsequently, the calculation signal buffer is configured to output a calculation signal in case that the difference value between the temporary signal and the historical signal is greater than the preset threshold; and not output a calculation signal in case that the difference between the temporary signal and the historical signal does not exceed the preset threshold. The calculation signal is a signal for difference calculation in a sampling selection mode being either an adaptive sampling mode or a non-adaptive sampling mode. The temporary buffer node 2 stores the temporary signal—an electrical signal corresponding to the current pixel location at the current time—while the historical buffer node 3 stores the historical signal I(x,y,tₙ), which is an electrical signal corresponding to the current pixel location at a historical time.

Thereafter, the internal update buffer 4 updates the historical signal with the temporary signal in the adaptive sampling mode and in case that the difference value between the temporary signal and the historical signal is greater than the preset threshold, does not update the historical signal in the adaptive sampling mode and in case that the difference value between the temporary signal and the historical signal is greater than the preset threshold and updates the historical signal with the temporary signal during every sampling in the non-adaptive sampling mode.

Finally, the spatiotemporal difference calculator 5 performs spatiotemporal difference computation on the calculation signal to obtain a spatiotemporal difference value. The spatiotemporal difference calculator 5 includes a temporal difference calculator and a spatial difference calculator; the spatiotemporal difference value includes a temporal difference value and a spatial difference value, where the temporal difference value is an output of the temporal difference calculator, and the spatial difference value is an output of the spatial difference calculator. This architecture simultaneously achieves high-performance visual information processing characterized by high speed, high precision, low calculation cost, low power consumption, and low bandwidth, breaking through the resource wall, a bandwidth wall, and a power consumption wall currently confronting vision sensors.

It can be understood that, both the temporal difference calculator and the spatial difference calculator of the present application may adopt an adaptive sampling-based difference calculation method; alternatively, one of both the temporal difference calculator and the spatial difference calculator may adopt the adaptive sampling method while the other thereof adopts a non-adaptive sampling method and there is no specific limitation thereto herein.

Furthermore, the vision sensor of the present application may include a temporal difference calculation unit and a spatial difference calculation unit corresponding to the spatiotemporal difference calculator 5 as well as a color (intensity) calculation unit. The pixel array composed of a plurality of pixels of the present application may be of a uniform type (i.e., the pixel array contains only one type of pixel); or a hybrid pixel array approach may be adopted (i.e., the pixel array contains multiple types of pixels); or, a combination of these two approaches may be employed. Specifically, the configurations include:
a tri-output multiplexed pixel (intensity, TD, SD);
a dual-input multiplexed pixel (intensity, TD) paired with an SD pixel, forming a binary hybrid array;
a dual-input multiplexed pixel (intensity, SD) paired with a TD pixel, forming a binary hybrid array;
a dual-input multiplexed pixel (TD, SD) paired with an intensity pixel, forming a binary hybrid array; and
a TD pixel, an SD pixel and an intensity pixel independently forming a ternary hybrid array.

Based on the embodiment above, the preset threshold is a fixed, programmable, or adaptive value.

To enable the recording, conversion, and readout of temporal variations in visual signals, the architecture of the present embodiment is configured such that each pixel outputs the difference between the current time tₙ and a specific historical time tᵣ. The value of tᵣ is determined adaptively by the pixel itself, and the data precision of this difference value is at least 2 bits or higher

$$Data ( x , y , {t}_{n} ) = Q ( I ( x , y , {t}_{n} ) - I ( x , y , {t}_{r} ) )$$

$$F ( x , y , {t}_{n} ) = \{ \begin{matrix}I ( x , y , {t}_{n} ) , & ABS ( I ( x , y , {t}_{n} ) - I ( x , y , {t}_{r} ) ) > TH \\ I ( x , y , {t}_{r} ) , & ABS ( I ( x , y , {t}_{n} ) - I ( x , y , {t}_{r} ) ) \leq TH\end{matrix} .$$

all signals mentioned above are three-dimensional quantities, including two spatial dimensions x and y and one temporal dimension t. Data (x,y,tₙ) represents the spatiotemporal difference value; I(x,y,tᵣ) represents the temporary signal; I(x,y,tₙ) represents the historical signal; Q denotes the quantization method; F(x,y,tₙ) represents the signal used to update the internal update buffer 4; ABS denotes the absolute value; and TH denotes the preset threshold.

The historical storage node continuously maintains the electrical signal at the position of the current pixel at a previous time until the difference between the stored signal and the newly obtained electrical signal at the position of the current pixel is greater than the preset threshold. The preset threshold may be configured as fixed, programmable, or adaptive (actively varying in accordance with the magnitude of the output signal F).

Regarding spatial difference calculation, taking the calculation in the y-direction as an example, the signal stored in the historical buffer node 3 is Iₕ(x,y,tₙ), while the signal stored in the temporary buffer node 2 is Iₜ(x,y+m,tₙ). If ABS(Iₜ(x,y+m,tₙ)−Iₕ(x,y,tₙ))≤TH, the output is then zero, and the process proceeds to switch to the next row Iₜ(x,y+m+1,tₙ), and in the next round, ABS(Iₜ(x,y+m+1,tₙ)−Iₕ(x,y,tₙ)) continues to be compared with TH. If ABS (Iₜ(x,y+m,tₙ)−Iₕ(x,y,tₙ))>TH, the current difference is calculated and quantized; subsequently, the historical and temporary buffers are swapped (i.e., during the next sampling e, the node currently storing Iₜ(x,y+m,tₙ) is designated as the buffer node, while the new data is written into the historical buffer; ABS(Iₜ(x,y+m+1,tₙ)−Iₕ(x,y+m,tₙ)) is compared with TH in next round. The final output is Data=Iₜ(x,y+m,tₙ)−Iₕ(x,y,tₙ).

In an embodiment, the photoreceptor 1 includes a photodiode, a transfer switch transistor, a reset switch transistor, and a buffer, where an anode of the photodiode is grounded, a cathode of the photodiode is connected to a first terminal of the transfer switch transistor; a second terminal of the transfer switch transistor is connected to a first terminal of the reset switch transistor and to a first terminal of the buffer, respectively; a second terminal of the reset switch transistor is connected to a positive power supply terminal; and a second terminal of the buffer serves as an output terminal of the photoreceptor 1.

In an embodiment, the temporary buffer node 2 includes a temporary buffer switch transistor and a temporary buffer capacitor; the historical buffer node 3 includes a historical buffer switch transistor and a historical buffer capacitor; and the internal update buffer 4 is a differential comparator; a first terminal of the temporary buffer switch transistor is connected to a second terminal of the buffer and to a first terminal of the historical buffer switch transistor, respectively; a second terminal of the temporary buffer switch transistor is connected to a first terminal of the temporary buffer capacitor and to a first input terminal of the differential comparator, respectively; a second terminal of the temporary buffer capacitor is grounded; a second terminal of the historical buffer switch transistor is connected to a first terminal of the historical buffer capacitor and to a second input terminal of the differential comparator, respectively; a second terminal of the historical buffer capacitor is grounded; and an output terminal of the differential comparator serves as an output terminal of the internal update buffer 4.

In an embodiment, the photoreceptor 1 is configured to acquire photosignals at the position of a current pixel at either a same time interval or an adaptive and programmable time interval.

In the present embodiment, the main core of the adaptive time-variable pixel architecture circuit lies in pixel-level adaptive sampling rate operation. Externally, either programmable triggers (featuring variable sampling intervals) or oversampling techniques are employed to execute synchronous, high-speed sampling across the entire array.

The internal update buffer 4 determines whether the internal history buffer node 3 needs to be updated; subsequently, the spatiotemporal difference calculator 5 directly outputs a high-precision analog differential calculation result. The quantization of these analog values into digital values may be performed either inside the pixel itself or by parallel circuitry located outside the pixel array.

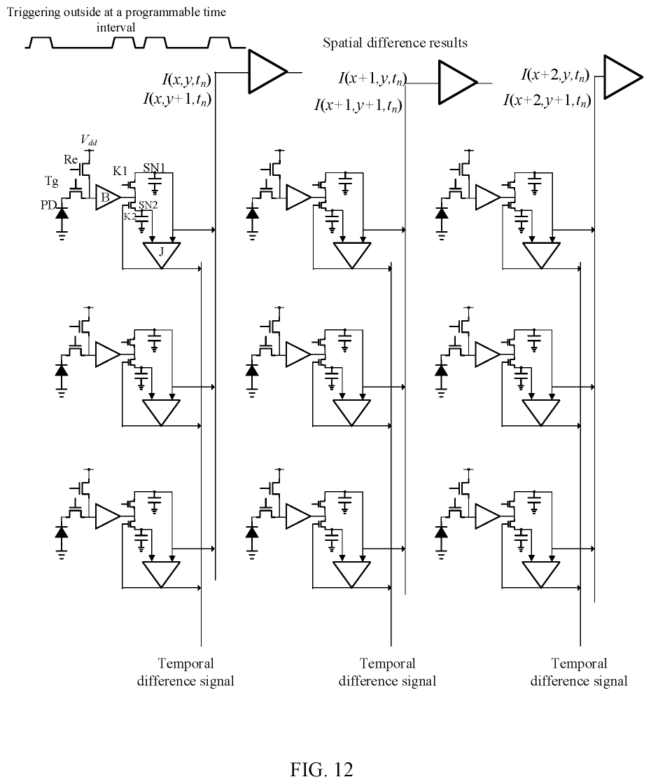

Reference is made to FIG. 12 and FIG. 12 is a first circuit diagram of a vision sensor chip based on an adaptive sampling technology according to the present application.

In an embodiment, each pixel of the pixel array is provided with single internal update buffer 4.

In the present embodiment, each column of pixels in the pixel array share a common spatiotemporal difference calculator 5, while each individual pixel is provided with its own internal update buffer 4. This configuration enables the internal update buffer 4 to update the electrical signals stored in the history buffer node 3 corresponding to the position of the current pixel, facilitating spatiotemporal difference calculations at programmable time intervals.

In an embodiment, the plurality of pixels share single internal update buffer 4.

To reduce the spatiotemporal redundancy inherent in the sensor architecture, in the present embodiment, each column of pixels in the pixel array share a common spatiotemporal difference calculator 5. Furthermore, the plurality of pixels, each column of pixels share single internal update buffer 4. This arrangement allows the internal update buffer 4 to update the electrical signals stored in the history buffer nodes 3 corresponding to the pixels within that column, effectively reducing the spatiotemporal redundancy of the sensor architecture.

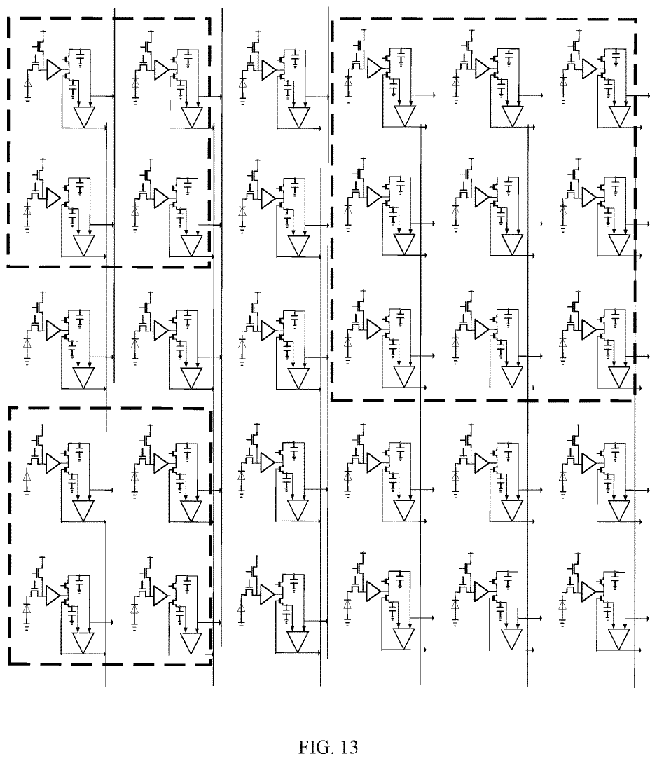

Reference is made to FIG. 13 and FIG. 13 is a second circuit diagram of a vision sensor chip based on an adaptive sampling technology according to the present application.

In an embodiment, the spatiotemporal difference calculator 5 is configured to perform spatiotemporal difference calculation based on the calculation signal of single pixel, and/or to perform spatiotemporal difference calculation based on the calculation signals of a pixel macroblock, where each pixel macroblock includes a plurality of pixels located within a preset region.

To further reduce the spatiotemporal redundancy of the sensor architecture, in the present embodiment, regions where temporal differences are generated output high-precision spatial differences based on the distribution of temporal differences obtained at an adaptive temporal sampling rate. Conversely, in regions exhibiting low temporal differences or generating no temporal differences, the plurality of pixels are binned into a pixel macroblock to calculate spatial differences. This binning method involves combining N×N pixels in a regular pattern and calculating the spatial difference of the resulting binned pixel macroblock, significantly reducing spatiotemporal difference redundancy and, in turn, lowering bandwidth requirements and power consumption while enhancing perception speed.

In an embodiment, the vision sensor chip further includes a convolver configured to perform convolution processing on the calculation signal or the spatiotemporal difference value to obtain a convolved spatiotemporal difference value.

In the present embodiment, the vision sensor chip based on the adaptive sampling technology further includes a convolver. The convolver employs convolution kernels (such as Gaussian kernels used for averaging filters) to perform convolution on the previously obtained high-resolution spatial differences to obtain low-resolution spatial differences. The corresponding formula is as follows:

$$I = {\sum }_{i = 1 … n} {k}_{i} I ( {x}_{i} , {y}_{i} , t )$$

where kᵢ represents a weight of the convolution kernel and the effect of the weight is to convolve a high-resolution (N×N) image matrix and perform down-sampling into single spatial difference value (1×1).

The convolver of the vision sensor chip of the present application may also be provided between the calculation signal buffer and the spatiotemporal difference calculator 5. The convolver performs convolution processing on the calculation signal output from the computed signal buffer to obtain convolved calculation signal; and the spatiotemporal difference calculator 5 subsequently performs spatiotemporal difference calculation on the convolved calculation signals to obtain the spatiotemporal difference value.

An imaging system according to the present application is described below and the imaging system described hereinafter may be referenced to the aforementioned vision sensor chip based on adaptive sampling technology.

According to the present application, there is further provided an imaging system including the aforementioned the vision sensor chip based on the adaptive sampling technology.

Finally, it should be noted that the above embodiments are only used to explain the solutions of the present application, and are not limited thereto; although the present application is described in detail with reference to the foregoing embodiments, it should be understood by those skilled in the art that they can still modify the solutions described in the foregoing embodiments and make equivalent replacements to a part of the features and these modifications and substitutions do not depart from the scope of the solutions of the embodiments of the present application.

What is claimed is:

1. A vision sensor chip, comprising a pixel array, at least one of a temporal difference pathway or a spatial difference pathway; wherein the pixel array comprises a plurality of pixels;
the temporal difference pathway is configured to perform weighted difference and quantization operations in a charge domain, an analog domain, or a digital domain on a signal at a position of a current pixel at a current time and a signal at the position of the current pixel at any previous time to obtain one or more types of multi-scale temporal difference value; and
the spatial difference pathway is configured to perform weighted difference and quantization operations in the charge domain, the analog domain, or the digital domain on the signal at the position of the current pixel at the current time and a signal at a position of any spatial pixel at the current time to obtain one or more types of multi-scale spatial difference value.

2. The vision sensor chip of claim 1, wherein
the temporal difference pathway comprises a plurality of temporally differential storage nodes, a temporal differentiator, and a temporal quantizer;
the plurality of temporally differential storage nodes are configured to store electrical signals at the position of the current pixel at a plurality of different times, respectively;
the temporal differentiator is configured to perform weighted temporal difference operation on an electrical signal at the position of the current pixel at the current time and an electrical signal at the position of the current pixel at any previous time based on the electrical signals at the position of the current pixel at the plurality of different times to obtain the multi-scale temporal difference values, wherein analog-to-digital signal conversion is performed by the temporal quantizer during a multi-scale temporal difference process;
the spatial difference pathway comprises a spatially differential storage node multiplexed with one of the plurality of temporally differential storage nodes, a spatial differentiator, and a spatial quantizer;
the spatially differential storage node is configured to store the electrical signal at the position of the current pixel at the current time; and
the spatial differentiator is configured to perform weighted spatial difference operation on the electrical signal at the position of the current pixel at the current time and an electrical signal at the position of any spatial pixel at the current time to obtain multi-scale spatial difference values, wherein the analog-to-digital signal conversion is performed by the spatial quantizer during a multi-scale spatial difference process.

3. The vision sensor chip of claim 2, wherein at least one of the temporal differentiator or the temporal quantizer is provided inside the pixel, and uses a pixel-level signal readout mode; or at least one of the temporal differentiator or the temporal quantizer is provided outside the pixel and shared by pixels located in a same column and uses a column-level signal readout mode; and
at least one of the spatial differentiator or the spatial quantizer is provided inside the pixel and uses the pixel-level signal readout mode; or at least one of the spatial differentiator or the spatial quantizer is provided outside the pixel and shared by pixels located in the same column and uses the column-level signal readout mode.

4. The vision sensor chip of claim 1, wherein each pixel of the pixel array is provided with a single pulse generator; or
all pixels in the pixel array are collectively connected to a single pulse generator; or
the pixel array is partitioned into a plurality of sub-regions and all pixels in each sub-region are collectively connected to a single pulse generator;
wherein the pulse generator is configured to generate a trigger signal at a fixed time interval, or at adaptive, programmable, and variable intervals to control a start exposure time and an exposure duration of a photoreceptor; pixels connected to a same pulse generator perform synchronous exposure, and pixels connected to different pulse generators perform either synchronous or asynchronous exposure; and
wherein the photoreceptor is provided inside the pixel and is configured to convert a photosignal received at the position of the current pixel into an analog electrical signal.

5. The vision sensor chip of claim 1, wherein an exposure mode for each pixel of the pixel array is a global shutter or a rolling shutter.

6. The vision sensor chip of claim 1, further comprising an internal update buffer;
wherein each of the plurality of pixels is provided with a photoreceptor and a calculation signal buffer comprising a temporary buffer node and a historical buffer node,
wherein the photoreceptor is configured to determine an electrical signal at the position of the current pixel, the electrical signal comprising a temporary signal and a historical signal;
the calculation signal buffer is configured to output a calculation signal in case that a calculation condition is satisfied, and to not output the calculation signal in case that the calculation condition is not satisfied, the calculation condition is that a difference value between the temporary signal and the historical signal is greater than a preset threshold, the calculation signal is a signal for difference calculation in a sampling selection mode being either an adaptive sampling mode or a non-adaptive sampling mode, the temporary signal is stored in the temporary buffer node and the historical signal is stored in the historical buffer node; and
the internal update buffer is configured to update the historical signal with the temporary signal in the adaptive sampling mode and in case that the calculation condition is satisfied and not to update the historical signal in the adaptive sampling mode and in case that the calculation condition is not satisfied and update the historical signal with the temporary signal during every sampling in the non-adaptive sampling mode.

7. The vision sensor chip of claim 6, wherein the preset threshold is a fixed, programmable, or adaptive value.

8. The vision sensor chip of claim 6, wherein the photoreceptor comprises a photodiode, a transfer switch transistor, a reset switch transistor, and a buffer,
wherein an anode of the photodiode is grounded, a cathode of the photodiode is connected to a first terminal of the transfer switch transistor; a second terminal of the transfer switch transistor is connected to a first terminal of the reset switch transistor and to a first terminal of the buffer, respectively; a second terminal of the reset switch transistor is connected to a positive power supply terminal; and a second terminal of the buffer serves as an output terminal of the photoreceptor.

9. The vision sensor chip of claim 8, wherein the temporary buffer node comprises a temporary buffer switch transistor and a temporary buffer capacitor; the historical buffer node comprises a historical buffer switch transistor and a historical buffer capacitor; and the internal update buffer is a differential comparator;
a first terminal of the temporary buffer switch transistor is connected to a second terminal of the buffer and to a first terminal of the historical buffer switch transistor, respectively; a second terminal of the temporary buffer switch transistor is connected to a first terminal of the temporary buffer capacitor and to a first input terminal of the differential comparator, respectively; a second terminal of the temporary buffer capacitor is grounded; a second terminal of the historical buffer switch transistor is connected to a first terminal of the historical buffer capacitor and to a second input terminal of the differential comparator, respectively; a second terminal of the historical buffer capacitor is grounded; and an output terminal of the differential comparator serves as an output terminal of the internal update buffer.

10. The vision sensor chip of claim 6, wherein the photoreceptor is configured to acquire photosignals at the position of the current pixel at either a same time interval or an adaptive and programmable time interval.

11. The vision sensor chip of claim 6, wherein each pixel is provided with a single internal update buffer.

12. The vision sensor chip of claim 6, wherein the plurality of pixels share a single internal update buffer.

13. The vision sensor chip of claim 6, wherein the spatiotemporal difference calculator is configured to perform spatiotemporal difference calculation based on the calculation signal of a single pixel, and/or to perform the spatiotemporal difference calculation based on calculation signals of a pixel macroblock, wherein the pixel macroblock comprises a plurality of pixels located within a preset region.

14. The vision sensor chip of claim 6, further comprising a convolver configured to perform convolution processing on the calculation signal or the temporal difference value or the spatial difference value.

15. A vision sensor chip, comprising a pixel array, an intensity pathway, at least one of a temporal difference pathway or a spatial difference pathway; wherein the pixel array comprises a plurality of pixels;
the intensity pathway is configured to determine a quantized value of an electrical signal converted from intensity of incident light at a position of a current pixel at a current time;
the temporal difference pathway is configured to perform weighted difference and quantization operations in a charge domain, an analog domain, or a digital domain on a signal at the position of the current pixel at the current time and a signal at the position of the current pixel at any previous time to obtain one or more types of multi-scale temporal difference value; and
the spatial difference pathway is configured to perform weighted difference and quantization operations in the charge domain, the analog domain, or the digital domain on the signal at the position of the current pixel at the current time and a signal at a position of any spatial pixel at the current time to obtain one or more types of multi-scale spatial difference value.

16. The vision sensor chip of claim 15, wherein the pixel array comprises a single type of pixel provided with an intensity pathway, and at least one of a temporal difference pathway or a spatial difference pathway corresponding to the single type of pixel; or the pixel array comprises two types of pixels, where a first type of pixel is provided with an intensity pathway, and a second type of pixel is provided with at least one of a temporal difference pathway or spatial difference pathway.

17. The vision sensor chip of claim 15, wherein
the intensity pathway comprises an intensity storage node and an intensity quantizer,
the intensity storage node is configured to store the electrical signal converted from the intensity of the incident light at the position of the current pixel at the current time;
the intensity quantizer is configured to perform analog-to-digital conversion on the electrical signal converted from the intensity of the incident light at the position of the current pixel at the current time to obtain a quantized value of the electrical signal converted from the intensity of the incident light at the position of the current pixel at the current time;
the temporal difference pathway comprises a plurality of temporally differential storage nodes, a temporal differentiator, and a temporal quantizer;
the plurality of temporally differential storage nodes are configured to store electrical signals at the position of the current pixel at a plurality of different times, respectively;
the temporal differentiator is configured to perform weighted temporal difference operation on the electrical signal at the position of the current pixel at the current time and the electrical signal at the position of the current pixel at any previous time based on the electrical signals at the position of the current pixel at the plurality of different times to obtain the multi-scale temporal difference values, wherein analog-to-digital signal conversion is performed by the temporal quantizer during a multi-scale temporal difference process;
the spatial difference pathway comprises a spatially differential storage node multiplexed with one of the temporally differential storage nodes, a spatial differentiator, and a spatial quantizer;
the spatially differential storage node is configured to store the electrical signal at the position of the current pixel at the current time; and
the spatial differentiator is configured to perform weighted spatial difference operation on the electrical signal at the position of the current pixel at the current time and an electrical signal at the position of any spatial pixel at the current time to obtain multi-scale spatial difference values, wherein the analog-to-digital signal conversion is performed by the spatial quantizer during a multi-scale spatial difference process.

18. The vision sensor chip of claim 17, wherein the intensity quantizer is provided inside the pixel, and uses a pixel-level signal readout mode; or the intensity quantizer is provided outside the pixel and shared by pixels located in a same column and uses a column-level signal readout mode; and
at least one of the temporal differentiator or the temporal quantizer is provided inside the pixel and uses the pixel-level signal readout mode; or at least one of the temporal differentiator or the temporal quantizer is provided outside the pixel and shared by pixels located in the same column and uses the column-level signal readout mode; and
at least one of the spatial differentiator or the spatial quantizer is provided inside the pixel and uses the pixel-level signal readout mode; or at least one of the spatial differentiator or the spatial quantizer is provided outside the pixel and shared by pixels located in the same column and uses the column-level signal readout mode.

19. The vision sensor chip of claim 15, wherein each pixel of the pixel array is provided with a single pulse generator; or
all pixels in the pixel array are collectively connected to a single pulse generator; or
the pixel array is partitioned into a plurality of sub-regions and all pixels in each sub-region are collectively connected to a single pulse generator;
wherein the pulse generator is configured to generate a trigger signal at a fixed time interval, or at adaptive, programmable, and variable intervals to control a start exposure time and an exposure duration of a photoreceptor; pixels connected to a same pulse generator perform synchronous exposure, and pixels connected to different pulse generators perform either synchronous or asynchronous exposure; and
wherein the photoreceptor is provided inside the pixel and is configured to convert a photosignal received at the position of the current pixel into an analog electrical signal.

20. The vision sensor chip of claim 15, wherein an exposure mode for each pixel of the pixel array is a global shutter or a rolling shutter.

21. The vision sensor chip of claim 15, further comprising an internal update buffer, wherein each of the plurality of pixels is provided with a photoreceptor and a calculation signal buffer comprising a temporary buffer node and a historical buffer node,
wherein the photoreceptor is configured to determine an electrical signal at the position of the current pixel, the electrical signal comprising a temporary signal and a historical signal;
the calculation signal buffer is configured to output a calculation signal in case that a calculation condition is satisfied, and to not output the calculation signal in case that the calculation condition is not satisfied, the calculation condition is that a difference value between the temporary signal and the historical signal is greater than a preset threshold, the calculation signal is a signal for difference calculation in a sampling selection mode being either an adaptive sampling mode or a non-adaptive sampling mode, the temporary signal is stored in the temporary buffer node and the historical signal is stored in the historical buffer node; and
the internal update buffer is configured to update the historical signal with the temporary signal in the adaptive sampling mode and in case that the calculation condition is satisfied and not to update the historical signal in the adaptive sampling mode and in case that the calculation condition is not satisfied and update the historical signal with the temporary signal during every sampling in the non-adaptive sampling mode.

22. The vision sensor chip of claim 21, wherein the preset threshold is a fixed, programmable, or adaptive value.

23. The vision sensor chip of claim 21, wherein the photoreceptor comprises a photodiode, a transfer switch transistor, a reset switch transistor, and a buffer,
wherein an anode of the photodiode is grounded, a cathode of the photodiode is connected to a first terminal of the transfer switch transistor; a second terminal of the transfer switch transistor is connected to a first terminal of the reset switch transistor and to a first terminal of the buffer, respectively; a second terminal of the reset switch transistor is connected to a positive power supply terminal; and a second terminal of the buffer serves as an output terminal of the photoreceptor.

24. The vision sensor chip of claim 23, wherein the temporary buffer node comprises a temporary buffer switch transistor and a temporary buffer capacitor; the historical buffer node comprises a historical buffer switch transistor and a historical buffer capacitor; and the internal update buffer is a differential comparator;
a first terminal of the temporary buffer switch transistor is connected to a second terminal of the buffer and to a first terminal of the historical buffer switch transistor, respectively; a second terminal of the temporary buffer switch transistor is connected to a first terminal of the temporary buffer capacitor and to a first input terminal of the differential comparator, respectively; a second terminal of the temporary buffer capacitor is grounded; a second terminal of the historical buffer switch transistor is connected to a first terminal of the historical buffer capacitor and to a second input terminal of the differential comparator, respectively; a second terminal of the historical buffer capacitor is grounded; and an output terminal of the differential comparator serves as an output terminal of the internal update buffer.

25. The vision sensor chip of claim 21, wherein the photoreceptor is configured to acquire photosignals at the position of the current pixel at either a same time interval or an adaptive and programmable time interval.

26. The vision sensor chip of claim 21, wherein each pixel is provided with a single internal update buffer.

27. The vision sensor chip of claim 21, wherein the plurality of pixels share a single internal update buffer.

28. The vision sensor chip of claim 21, wherein the vision sensor chip is configured to perform spatiotemporal difference calculation based on the calculation signal of a single pixel, and/or to perform the spatiotemporal difference calculation based on calculation signals of a pixel macroblock, wherein the pixel macroblock comprises a plurality of pixels located within a preset region.

29. The vision sensor chip of claim 21, further comprising a convolver configured to perform convolution processing on the calculation signal or the temporal difference value or the spatial difference value.

30. An imaging system, comprising the vision sensor chip of claim 1.

31. An imaging system, comprising the vision sensor chip of claim 15.
